(19) United States
(12) Patent Application Publication
(10) Pub. No.: US 2019/0020795 A1
(43) Pub. Date: Jan. 17, 2019

(54) CAMERA MODULE AND ELECTRONIC DEVICE

(71) Applicant: LITE-ON ELECTRONICS (GUANGZHOU) LIMITED, GUANGZHOU (CN)

(72) Inventor: Yongdong Tian, GUANGZHOU (CN)

(73) Assignee: LITE-ON ELECTRONICS (GUANGZHOU) LIMITED, GUANGZHOU (CN)

(21) Appl. No.: 15/823,567

(22) Filed: Nov. 28, 2017

(30) Foreign Application Priority Data
Jul. 17, 2017 (CN) 201720864894.8

(51) Int. Cl. H04N 5/225; G02B 7/02

(52) U.S. Cl. CPC H04N 5/2254; H04N 5/2257; G02B 7/021; H04N 5/2253

(57) ABSTRACT

A camera module including a carrying board, an image sensor, a holder, a lens barrel, and at least one lens is provided. The image sensor is disposed on the carrying board. The holder is disposed on the carrying board and surrounds the image sensor. The lens barrel is fixed on the holder. The lens is disposed in the lens barrel and above the image sensor. A height of a top end of the holder is higher than that of a top end of the lens barrel, and the holder is a height positioning member. An electronic device is also provided.

### CROSS REFERENCE TO RELATED APPLICATION

This application claims the priority benefit of China application serial no. 201720864894.8, filed on Jul. 17, 2017. The entirety of the above-mentioned patent application is hereby incorporated by reference herein and made a part of specification.

### BACKGROUND OF THE INVENTION

### Field of the Invention

The invention is related to an optical module and an electronic device including an optical module, and particularly to a camera module and an electronic device including the camera module.

### Description of Related Art

Nowadays a camera module has been widely applied in many fields such as the photographing function of a hand-held electronic device (e.g., mobile phones, tablet PC or cameras). Also, a camera module is applied to a monitor, a drive recorder, a back monitor or even an imaging system for industrial or medical purposes, and so on.

In a conventional camera module, a lens barrel is generally protruded upward from a holder. Therefore, when the camera module is assembled in a housing of an electronic device, a quite large gap is formed between a cover of the housing and a top end of the holder. At this point, generally a foam is disposed within the gap so that the gap can be kept between the cover and the holder, and that the pressure subjected to the cover can be dispersed by the foam so as to prevent the camera module from being damaged by the pressure.

However, such a gap causes the thickness of the foam to be overly thick and thus a deviation in the amount of compression of the foam can easily cause a deviation in the gap to be overly large, which easily causes the relative positions of the cover and the camera module to vary and that the deviation in the position exceeds a tolerance range.

### SUMMARY OF THE INVENTION

The invention provides a camera module of which the height may have a smaller tolerance.

The invention provides an electronic device which has a smaller assembling tolerance and a higher yield rate on the premises that a good imaging quality is achieved.

An embodiment of the invention provides a camera module including a carrying board, an image sensor, a holder, a lens barrel and at least one lens. The image sensor is deposed on the carrying board; the holder is disposed on the carrying board and surrounds the image sensor. The lens barrel is fixed on the holder; the lens is disposed in the lens barrel and located above the image sensor. A height of a top end of the holder is higher than that of a top end of the lens barrel, and the holder is a height positioning member.

An embodiment of the invention provides an electronic device, including a camera module, a cover and an elastic pad. The camera module includes a carrying board, an image sensor, a holder, a lens barrel and at least one lens. The image sensor is disposed on the carrying board; the holder is disposed on the carrying board and surrounds the image sensor. The lens barrel is fixed on the holder; the lens is disposed in the lens barrel and located above the image sensor. A height of a top end of the holder is higher than that of a top end of the lens barrel, and the holder is a height positioning member. The cover is disposed above the camera module, and the elastic pad is disposed between the top end of the holder and the cover.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of an electronic device according to an embodiment of the invention.

### DESCRIPTION OF EMBODIMENTS

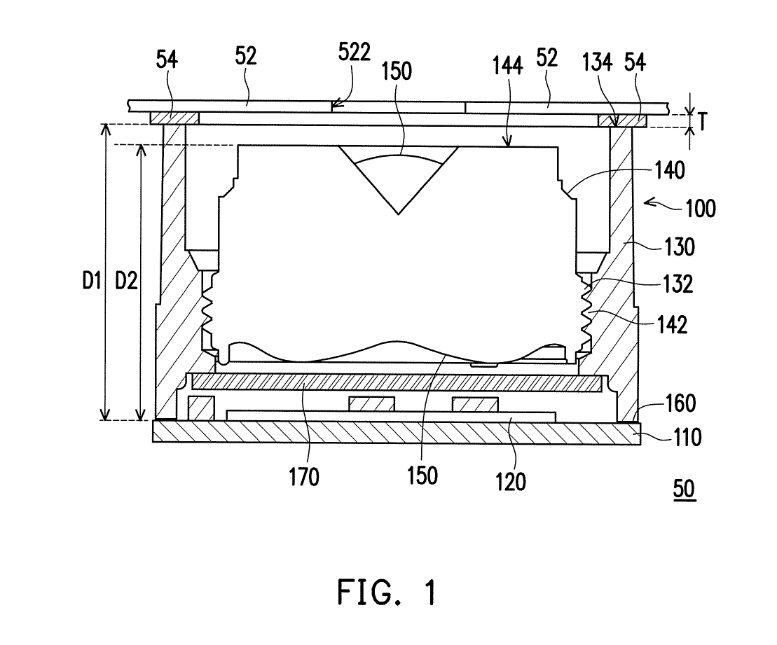

FIG. 1 is cross-sectional view of an electronic device according to an embodiment of the invention. Referring to FIG. 1, an electronic device 50 of the embodiment includes a camera module 100, a cover 52 and an elastic pad 54. The camera module 100 includes a carrying board 110, an image sensor 120, a holder 130, a lens barrel 140 and at least one lens 150 (it is exemplified in the embodiment that there are a plurality of lens 150 in the lens barrel 140). The image sensor 120 is disposed on the carrying board 110. In the embodiment, the carrying board 110 is, for example, a circuit board, which transmits a signal from the image sensor 120 to other components or devices outside the camera module 100. In addition, in the embodiment, the image sensor 120 is, for example, a complementary metal oxide semiconductor (CMOS) image sensor, a charge coupled device (CCD), or other suitable image sensors.

The holder 130 is disposed on the carrying board 110 and surrounds the image sensor 120. In the embodiment, the camera module 100 further includes an adhesive layer 160 disposed between the holder 130 and the carrying board 110 and bonding the holder 130 onto the carrying board 110. The material of the adhesive layer 160 may be various types of paste, adhesive, thermal-curable resin, photo-curable resin or other material that can adhere the holder to the carrying board 110. The above recitation that “the holder 130 is disposed on the carrying board 110” may refer to “the holder 130 is directly disposed on the carrying board 110” or “the holder 130 is indirectly disposed on the carrying board 110 via other element.” For example, the holder 130 may be disposed on an electronic component on the carrying board 110, or disposed on a non-photosensitive peripheral area of the image sensor 120 on the carrying board 110. The electronic component and the non-photosensitive peripheral area of the image sensor 120 may be covered with paste (e.g., thick paste), and the holder 130 is disposed or adhered to the paste.

The lens barrel 140 is fixed on the holder 130. In the embodiment, an external side of the lens barrel 140 and an inner side of the holder 130 may respectively have a thread 132 and a thread 142. The thread 132 and the thread 142 match each other so that the lens barrel 140 can be rotated into the holder 130 and fixed on the holder 130. However, in other embodiment, the lens barrel 140 may be fixed on the holder 130 via other means such as through locking, screwing, adhering or other proper means.

The lenses 150 are disposed in the lens barrel 140 and located above the image sensor 120. A height of a top end 134 of the holder 130 is higher than that of a top end 144 of the lens barrel 140. In other words, the top end 134 of the holder 130 protrudes more than the top end 144 of the lens barrel 140. For example, when the carrying board 110 serves as a basis, a distance D1 from the top end 134 of the holder 130 to the carrying board 110 is larger than a distance D2 from the top end 144 of the lens barrel 140 to the carrying board 110. In this manner, the holder 130 may further serve as a height positioning member for positioning.

In the embodiment, the electronic device 50 is, for example, a mobile phone, a tablet PC, a smart phone, a personal digital assistant (PDA), a digital camera, a notebook computer, other portable electronic devices or other electronic devices requiring photographing function. The cover 52 of the electronic device 50 is disposed above the camera module 100. The elastic pad 54 is disposed between the top end 134 of the holder 130 and the cover 52, and bears a pressing force from the cover 52 and the top end 134 of the holder 130. In the embodiment, the material of the elastic pad 54 is, for example, a foam or other appropriate elastic materials compressible in thickness. In addition, in the embodiment, since the height of the top end 134 of the holder 130 is higher than that of the top end 144 of the lens barrel 140, a thickness T of the elastic pad 54 disposed on the top end 134 of the holder 130 can be smaller.

In the camera module 100 and the electronic device 50 of the embodiment, the height of the top end 134 of the holder 130 is higher than that of the top end 144 of the lens barrel 140, and the holder 130 is a height positioning member; therefore, the camera module 100 can have a smaller height tolerance, and the gap between the cover 52 and the holder 130 can be shorter so that the thickness T of the elastic pad 54 is smaller. In this manner, the assembling yield rate of the electronic device 50 can be effectively improved and the assembling tolerance can be effectively reduced. Specifically, since the top end 134 of the holder 130 is higher than the top end 144 of the lens barrel 140, the height of the camera module 100 may be subject to the thicknesses of the holder 130, the carrying board 110 and the adhesive layer 160 therebetween. In other words, the height tolerance of the camera module 100 is subject to a thickness tolerance of the carrying board 110, a thickness tolerance of the adhesive layer 160 and the height tolerance of the holder 130. With respect to the design that the lens barrel is protruded from the holder, a height tolerance of the camera module thereof is subject to four tolerances, i.e., a thickness tolerance of the carrying board, a thickness tolerance of the adhesive layer between the image sensor and the carrying board, a thickness tolerance of the image sensor and a tolerance of a total track length (TTL) of the lens. By comparison, since the height tolerance of the camera module 100 of the embodiment is subject to the three tolerances described above, the height tolerance of the camera module 100 can be effectively reduced, thereby enhancing the assembling yield rate and the assembling quality of the electronic device 50.

For example, in the design that the lens barrel is protruded from the holder, the thickness tolerance of the carrying board is, for example, ±0.05 mm; the thickness tolerance of the adhesive layer between the image sensor and the carrying board is, for example, ±0.02 mm; the thickness tolerance of the image sensor is, for example, ±0.015 mm; the tolerance of TTL of the lens is, for example, ±0.07 mm. In this manner, through a tolerance analysis of ±4 standard deviations, the height tolerance of the camera module is, for example, ±0.119 mm. By comparison, in the camera module 100 of the embodiment, the thickness tolerance of the carrying board 110 is, for example, ±0.05 mm, the thickness tolerance of the adhesive layer 160 is, for example, ±0.02 mm, the height tolerance of the holder 130 is, for example, ±0.05 mm. Through the tolerance analysis of ±4 standard deviations, the height tolerance of the camera module 100 of the embodiment, is, for example, 0.098 mm, which is obviously smaller than the ±0.119 mm in the design that the lens barrel is protruded from the holder. Therefore, when it is required that the height tolerance of the camera module is to be changed from ±0.15 mm to ±0.10 mm so as to meet the requirement of slim products, the design that the lens barrel is protruded from the holder with the height tolerance of ±0.119 mm cannot satisfy such requirement; however, the height tolerance, e.g., ±0.098 mm, of the camera module 100 of the embodiment can satisfy such requirement and have a better process capability index.

In addition, since the gap between the cover 52 and the holder 130 is smaller, the thickness T of the elastic pad 54 can be reduced and thus the amount of compression of the elastic pad 54 can be smaller as well, thereby better controlling the distance (i.e., equivalent to the thickness T added with distance D1) between the cover 52 and the carrying board 110. Accordingly, the assembling yield rate and the assembling quality of the electronic device 50 can be effectively improved.

On the other hand, if it is designed that the lens barrel is protruded from the holder and the foam is disposed between the cover and the lens barrel of the electronic device, since the lens barrel is pressed by the cover via the foam, a change of the TLL can easily occur to affect the imaging quality. In addition, in the conventional design that the lens barrel is protruded from the holder and the foam is disposed between the holder and the cover, since the thickness of the foam needs to be very thick, if the used thickness or amount of compression of the foam is improper, when the thickness of the foam is compressed, it is still likely that the lens barrel is pressed by the cover and the imaging quality is affected. By comparison, in the electronic device 50 of the embodiment, since the holder 130 is protruded from the lens barrel 140, when the cover 52 is pressed downward, the cover 52 presses the holder 130 without pressing the lens barrel 140. Therefore, the camera module 100 of the embodiment can have a good imaging quality. Furthermore, in the electronic device 50 of the embodiment, since the elastic pad 54 is disposed between the cover 52 and the top end of the holder 130, the pressing force from the cover 52 and the top end 134 of the holder 130 is borne by the elastic pad 54 and a thinner elastic pad 54 can be used so that the amount of compression of the elastic pad 54 in thickness can be more easily controlled, thereby reducing the deviation caused by the elastic pad 54.

In the embodiment, the cover 52 is, for example, a front cover or a rear cover of the electronic device 50 and has a light transmissive opening 522. Moreover, the top end 134 of the holder 130 and the elastic pad 54 may be formed in a ring shape or have a circle opening in its center. The light from ambient scenes enters the electronic device 50 via the light transmissive opening 522 of the cover 52. Then, after passing through the opening of the elastic pad 54, the light is imaged on the image sensor 120 by the lenses 150 so as to form an image on the image sensor 120. Furthermore, in the embodiment, the camera module 100 may further include a filter 170 fixed on the holder 130 and disposed between the lens 150 and the image sensor 120. The filter 170 is, for example, an infrared cut-off filter or a filter that filters a certain waveband of light depending on the needs.

In summary, in the camera module and electronic device of the embodiment of the invention, the height of the top end of the holder is higher than that of the top end of the lens barrel, and the holder is the height positioning member. Therefore, the camera module can have a smaller height tolerance, and the gap between the cover and the holder can be shorter so that the thickness of the elastic pad can be smaller, thereby effectively improving the assembling yield rate of the electronic device and effectively reducing assembling tolerance. In addition, since the holder is protruded from the lens barrel, and the elastic pad is disposed between the cover and the top end of the holder to bear the pressing force from the cover and the top end of the holder, instead of subjecting the lens barrel to the pressing force from the cover, the camera module can have a good imaging quality.

It will be apparent to those skilled in the art that various modifications and variations can be made to the structure of the invention without departing from the scope or spirit of the invention. In view of the foregoing, it is intended that the invention covers modifications and variations of this invention provided they fall within the scope of the following claims and their equivalents.

What is claimed is:

1. A camera module, comprising:
a carrying board;
an image sensor, disposed on the carrying board;
a holder, disposed on the carrying board and surrounding the image sensor;
a lens barrel, fixed on the holder; and
at least a lens, disposed in the lens barrel and located above the image sensor,
wherein a height of a top end of the holder is higher than that of a top end of the lens barrel, and the holder is a height positioning member.

2. The camera module according to claim 1, further comprising an adhesive layer, disposed between the holder and the carrying board and bonding the holder onto the carrying board.

3. The camera module according to claim 2, wherein a height tolerance of the camera module is subject to a thickness tolerance of the carrying board, a thickness tolerance of the adhesive layer and a height tolerance of the holder.

4. The camera module according to claim 1, wherein the carrying board is a circuit board.

5. An electronic device, comprising:
a camera module, comprising:
a carrying board;
an image sensor, disposed on the carrying board;
a holder, disposed on the carrying board and surrounding the image sensor;
a lens barrel, fixed on the holder; and
at least a lens, disposed in the lens barrel and located above the image sensor,
wherein a height of a top end of the holder is higher than that of a top end of the lens barrel, and the holder is a height positioning member;
a cover, disposed above the camera module; and
an elastic pad, disposed between the top end of the holder and the cover.

6. The electronic device according to claim 5, wherein the camera module further comprises an adhesive layer, disposed between the holder and the carrying board and bonding the holder onto the carrying board.

7. The electronic device according to claim 6, wherein a height tolerance of the camera module is subject to a thickness tolerance of the carrying board, a thickness tolerance of the adhesive layer and a height tolerance of the holder.

8. The electronic device according to claim 5, wherein the carrying board is a circuit board.

9. The electronic device according to claim 5, wherein a material of the elastic pad is a foam.

10. The electronic device according to claim 5, wherein the elastic pad bears a pressing force from the cover and the top end of the holder.
